(19) United States
(12) Patent Application Publication
(10) Pub. No.: US 2026/0014643 A1
(43) Pub. Date: Jan. 15, 2026

(54) LASER SURFACE TREATMENT DEVICE AND LASER SURFACE TREATMENT SYSTEM

(71) Applicant: FURUKAWA ELECTRIC CO., LTD., Tokyo (JP)

(72) Inventors: Tetsuya KON, Tokyo (JP); Yoshihiro NISHIGATA, Tokyo (JP); Ryosuke NISHII, Tokyo (JP); Keita SAKUYAMA, Tokyo (JP); Kazuyuki UMENO, Tokyo (JP); Kohei KOYAMA, Tokyo (JP); Kazuki SUZUKI, Tokyo (JP)

(73) Assignee: FURUKAWA ELECTRIC CO., LTD., Tokyo (JP)

(21) Appl. No.: 19/330,386

(22) Filed: Sep. 16, 2025

Related U.S. Application Data
(63) Continuation of application No. PCT/JP2024/010341, filed on Mar. 15, 2024.

(30) Foreign Application Priority Data
Mar. 17, 2023 (JP) 2023-043417

(51) Int. Cl. B23K 26/06; B23K 26/03; B23K 26/064; B23K 26/082; B23K 26/36

(52) U.S. Cl. CPC B23K 26/0626; B23K 26/032; B23K 26/034; B23K 26/064; B23K 26/082; B23K 26/36

(57) ABSTRACT

A laser surface treatment device includes: a laser device configured to output laser light; an optical head configured to irradiate a surface of an object with the laser light output from the laser device; a detection processing unit configured to detect a physical quantity that changes according to irradiation of the laser light; and a control unit configured to control, based on the physical quantity detected by the detection processing unit, at least either power of the laser light output from the optical head or an irradiation position of the laser light on the surface. Treatment of the surface is carried out by irradiating the surface with the laser light.

This application is a continuation of International Application No. PCT/JP2024/010341, filed on Mar. 15, 2024 which claims the benefit of priority of the prior Japanese Patent Application No. 2023-043417, filed on Mar. 17, 2023, the entire contents of which are incorporated herein by reference.

### BACKGROUND

The present disclosure relates to a laser surface treatment device and a laser surface treatment system.

In the related art, a method is known by which the coating film or the deposit present on the surface of a structure is removed using laser irradiation (for example, refer to Japanese Patent No. 5574354).

### SUMMARY

During surface removal using laser irradiation, for example, when the surface has asperity, there is a risk that the reflected light of the irradiated laser travels from the surface in unintended directions. Hence, ensuring the safety becomes a critical issue.

Meanwhile, it would be beneficial if the operating state of the constituent elements may be detected, such as whether or not the surface is irradiated with the laser light in a predetermined state and whether there is no abnormality inside a laser surface treatment device, and if the detected state may be archived as data and notified using communication for enabling improvement.

There is a need for a laser surface treatment device and a laser surface treatment system of a new and improved type that enable achieving enhancement in the safety and improving the state of laser irradiation.

According to one aspect of the present disclosure, there is provided a laser surface treatment device including: a laser device configured to output laser light; an optical head configured to irradiate a surface of an object with the laser light output from the laser device; a detection processing unit configured to detect a physical quantity that changes according to irradiation of the laser light; and a control unit configured to control, based on the physical quantity detected by the detection processing unit, at least either power of the laser light output from the optical head or an irradiation position of the laser light on the surface, wherein treatment of the surface is carried out by irradiating the surface with the laser light.

### BRIEF DESCRIPTION OF THE DRAWINGS

FIG. 1 is an illustrative overall configuration diagram of a laser surface treatment device common to embodiments;

FIG. 2 is a schematic planar view illustrating an exemplary scanning path that is of a laser light irradiated from the laser surface treatment device common to the embodiments and that is formed on a surface of an object;

FIG. 3 is an illustrative and schematic front view of a laser irradiation device included in the laser surface treatment device according to the first embodiment;

FIG. 4 is an illustrative block diagram of a control device included in the laser surface treatment device common to the embodiments;

FIG. 5 is a schematic diagram that, when an area temperature sensor is disposed as a sensor in the laser surface treatment device according to the first embodiment, illustrates an example of the temperature distribution on the surface of an object as obtained by the area temperature sensor;

FIG. 6 is a schematic diagram that, when an optical sensor is disposed as a sensor in the laser surface treatment device according to the first embodiment, illustrates an example of the temporal changes occurring in the intensity detected by the optical sensor;

FIG. 7 is a schematic diagram that, when an optical sensor is disposed as a sensor in the laser surface treatment device according to the first embodiment, illustrates another example of the temporal changes in the intensity detected by the optical sensor as a different example than the example illustrated in FIG. 6;

FIG. 8 is a schematic diagram that, when an area image sensor is disposed as a sensor in the laser surface treatment device according to the first embodiment, illustrates an example of an image obtained by the area image sensor;

FIG. 9 is a schematic diagram that, when an area image sensor is disposed as a sensor in the laser surface treatment device according to the first embodiment, illustrates another example of an image obtained by the area image sensor;

FIG. 10 is an illustrative and schematic front view of a laser irradiation device according to a second embodiment;

FIG. 11 is a schematic diagram that, when three area temperature sensors are disposed as sensors in the laser irradiation device according to the second embodiment, illustrates an example of the detection ranges of the temperature distributions obtained by the three area temperature sensors;

FIG. 12 is a graph that, when three optical sensors are disposed as sensors in the laser irradiation device according to the second embodiment, illustrates an example of the temporal changes occurring in the intensities detected by the three optical sensors;

FIG. 13 is a graph that, when three optical sensors are disposed as sensors in the laser irradiation device according to the second embodiment, illustrates another example of the temporal changes occurring in the intensities detected by the three optical sensors;

FIG. 14 is an overall configuration diagram of some portion of a laser surface treatment device according to a third embodiment;

FIG. 15 is an illustrative and schematic side view of an internal configuration of some portion of a laser irradiation device included in a laser surface treatment device according to a fourth embodiment;

FIG. 16 is a schematic planar view illustrating an example of a spot pattern that is formed on a virtual irradiated surface by the laser irradiation device included in the laser surface treatment device according to the fourth embodiment;

FIG. 17 is an overall configuration diagram of a laser surface treatment system according to a fifth embodiment; and

FIG. 18 is an illustrative block diagram of a control device included in the laser surface treatment device according the fifth embodiment.

### DETAILED DESCRIPTION

Exemplary embodiments of the present disclosure are described below. The configurations explained in the embodiments described below as well as the actions and the results (effects) attributed to the configurations are only exemplary. Thus, the present disclosure may be implemented also using some different configuration than the configurations disclosed in the embodiments described below. Meanwhile, according to the present disclosure, it becomes possible to achieve at least one of various effects (including secondary effects) that are attributed to the configurations.

The embodiments described below include identical constituent elements. In the following explanation, the identical constituent elements are referred to by the same reference numerals, and their explanation is not given in a repeated manner.

In the present written description, ordinal numbers are assigned only for convenience and with the aim of differentiating among the directions and the portions. Thus, the ordinal numbers neither indicate the priority or the sequencing nor restrict the count.

In the drawings, the X direction is indicated by an arrow X, the Y direction is indicated by an arrow Y, and the Z direction is indicated by an arrow Z. The X direction, the Y direction, and the Z direction intersect with each other and are orthogonal to each other.

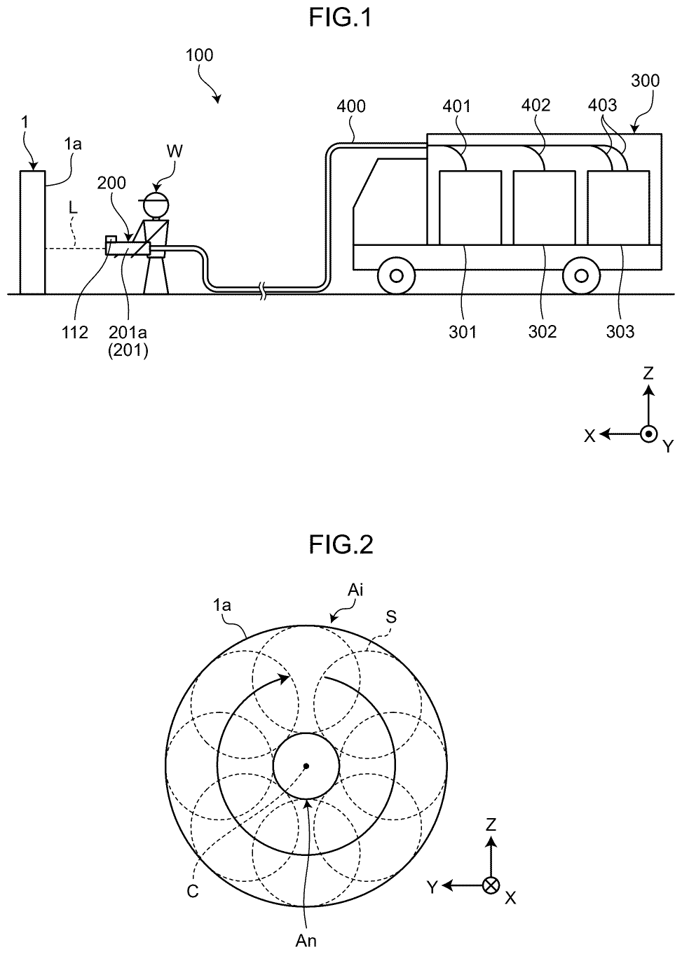

FIG. 1 is a diagram illustrating an overall configuration of a laser surface treatment device 100 common to embodiments of the present disclosure. As illustrated in FIG. 1, a laser surface treatment device 100 includes a portable laser irradiation device 200, a mount device 300, and a cable 400.

The laser irradiation device 200 irradiates a surface 1a of a subject 1, from which the surface layer is to be removed, with a laser light L. When the laser light L is bombarded under appropriate conditions, the energy of the laser light L causes laser abrasion at that position on the surface la which is irradiated with the laser L and in the vicinity of that position; and a thin portion of the surface layer gets removed. At that time, the subject 1 from which the material constituting the body (preform), which includes the surface la of the subject 1, is removed and from which dirt, rust, or an applied material such as a coating film or a paint is removed represents an example of a target object for processing (e.g., surface treatment).

Examples of the subject 1 cover a wide range including a building, a building structure, an architecture, a building material, a product, and a component. Examples of the constituent material of the subject 1 include, but are not limited to, a metal, concrete, or mortar. The subject 1 represents an example of an object.

A worker W uses the laser irradiation device 200 by holding it. Thus, by changing one's own position, the worker W becomes able to change the position of the laser irradiation device 200. Moreover, by changing the orientation of the laser irradiation device 200, the worker W becomes able to change the output direction of the laser light L coming out from the laser irradiation device 200. That is, by changing the position or the orientation of the laser irradiation device 200, the worker W becomes able to change the position on the surface la to be irradiated with the laser light L for removal of the surface layer. As a result, the worker W may perform the task of removing the surface layer over a wide range of the surface la.

The mount device 300 is used to mount various devices such as a laser device 301, a power source device 302, and a cooling device 303. Since those devices may be large and heavy, they are difficult to mount in the laser irradiation device 200. In that regard, in the laser surface treatment device 100, the devices mounted in the mount device 300 are separated from the laser irradiation device 200; and the mount device 300 is connected to the laser irradiation device 200 using a cable 400. That enables achieving reduction in the weight and the size of the laser irradiation device 200. Moreover, in order to ensure that the surface la may be treated over a relatively wider range and away from the mount device 300, the length of the cable 400 is kept to be relatively long.

The mount device 300 is, for example, a mobile object such as a truck (an automobile or a vehicle). Since the mount device 300 is mobile in nature, the location for performing surface layer removal using the laser surface treatment device 100 may be changed with ease. Meanwhile, the mount device 300 is not limited to be an automobile and, for example, alternatively may be a vehicle other than an automobile, such as a train, or may be a ship. Still alternatively, for example, as in the case of a trailer, the mount device 300 need not equipped with a power source.

The laser device 301 includes a laser oscillator and, as an example, is configured to be able to output a laser light having the power of 600 [W]. The laser oscillator represents an example of a laser device. The laser light output by the laser oscillator has the wavelength of, for example, equal to or greater than 400 [nm] and equal to or smaller than 1200 [nm]. As a representative example, a fiber laser oscillator having the wavelength of 1070 [nm] is mounted. Alternatively, a semiconductor laser oscillator having the wavelength of 940 [nm] may be used, or a semiconductor laser device having the wavelength of 450 [nm] may be used, or a disk laser or a solid-state laser having the wavelength of 1064 [nm] may be used. Alternatively, in order to enhance the efficiency of removing the surface layer, the laser device 301 may be a continuous wave laser.

The laser device 301 and the laser irradiation device 200 are optically connected to each other via an optical fiber cable 401. The optical fiber cable 401 includes an optical fiber (not illustrated) that has a core and has a cladding which encloses the core. The optical fiber transmits the laser light, which is output from the laser device 301, to the laser irradiation device 200.

In view of the application with respect to the subject 1 such as a building, a building structure, or an architecture that is relatively large in size, in order to secure a relatively long distance between the laser device 301 and the laser irradiation device 200, the length of the optical fiber cable 401, in turn, the length of the cable 400 is set to be, for example, equal to or greater than 5 [m] and equal to or smaller than 300 [m]. The optical density and the transmission-enabling cable length have a tradeoff relationship attributed to the energy shift caused by stimulated Raman scattering. Hence, in order to achieve transmission of a laser light over such a long distance, the diameter of the core of the optical fiber is desirably equal to or greater than 50 [μm], is more desirably equal to or greater than 80 [μm], and is still more desirably equal to or greater than 100 [μm].

Moreover, in order to obtain a high-quality treatment surface (a surface layer removal surface) having less treatment unevenness and high shape accuracy, it is crucial to maintain high quality of the laser light that is output from the optical fiber to the laser irradiation device 200. From that perspective, regarding the specifications including the length and the diameter as mentioned above, an optical fiber is configured in such a way that the laser light, which is output from the optical fiber, has the M² beam quality to be equal to or smaller than 10. The M²beam quality may also be referred to as the M² beam factor. When the optical fiber is a single-mode optical fiber, the M² beam quality is set to be equal to or smaller than 1.5. In that case, the output of the laser light is set to be equal to or greater than 300 [W] and equal to smaller than 5000 [W]. When the optical fiber is a multimode optical fiber, the M² beam quality is set to be equal to or smaller than 10. In that case, the output of the laser light is set to be equal to or greater than 500 [W] and equal to smaller than 20000 [W].

The power source device 302 includes, for example, a battery or a power generator for supplying the laser irradiation device 200 with necessary electrical power required for the operation of the constituent elements. The electrical power is supplied to the laser irradiation device 200 from the power source device 302 via an electrical cable 402.

The cooling device 303 includes, for example, a tank filled with a refrigerant, such as a coolant, and a pump for discharging the refrigerant; and supplies the refrigerant to the laser irradiation device 200 for the purpose of cooling the constituent elements. The refrigerant is supplied to the laser irradiation device 200 from the cooling device 303 via a refrigerant tube 403.

The laser irradiation device 200 is an optical device that appropriately irradiates the subject 1 with the laser light that is input from the laser device 301 via the optical fiber cable 401. Inside a housing 201 of the laser irradiation device 200, optical components such as a lens, a mirror, and a DOE are housed.

From the laser irradiation device 200, the laser light L is output that is formed with a predetermined beam diameter or a predetermined beam shape depending on the optical components. The laser light L is emitted onto the surface la of the subject 1. The laser irradiation device 200 represents an example of an optical head. Alternatively, an optical head may be housed inside the housing 201 of the laser irradiation device 200.

The laser irradiation device 200 is capable of operating in a normal output mode and in a low output mode in which the output power of the laser light L is lower than the output power in the normal output mode. The output power in the normal output mode as well as the low output mode may be set in advance. The low output mode may also be called the safety mode.

Meanwhile, the laser irradiation device 200 has a laser scanner disposed therein. FIG. 2 is a planar view of the surface la illustrating an exemplary scanning path of a spot S of the laser light L on the surface la. As illustrated in FIG. 2, the spot S circles around a center C (the rotation center for scanning), and the laser scanner forms ring-shaped irradiated areas Ai due to which a non-irradiated area An that is not directly irradiated gets formed in the vicinity of the center C. Such a scanning path may be implemented when, for example, the laser scanner includes optical components through which the laser light passes inside the housing 201 and includes a motor for rotating the optical components; and the optical components are rotated using the motor so as to rotate the output direction of the laser light L. The laser scanner represents an example of a scanning mechanism.

If the spot S is scanned in such a way that the non-irradiated area An is not formed, the energy density of the laser light L goes on increasing more toward the center C, and there occurs variability in the energy density depending on the position of the irradiated area Ai. That leads to a risk of having unevenness in the treatment. In that regard, since the irradiated areas Ai are formed as ring-shaped areas that enclose the non-irradiated area An, the energy density becomes excessively high at the positions close to the center C, and it becomes possible to hold down the state in which unevenness in the treatment tends to occur. When the worker W moves the housing 201 of the portable laser irradiation device 200 in such a way that the emitting area Ai shifts over the surface la, the non-irradiated area An may also be treated. Moreover, the heat of the laser light L emitted onto the irradiated areas Ai is transmitted to the non-irradiated area An, thereby sometimes enabling treatment of the non-irradiated area An. The size of the non-irradiated area An is set in an appropriate manner.

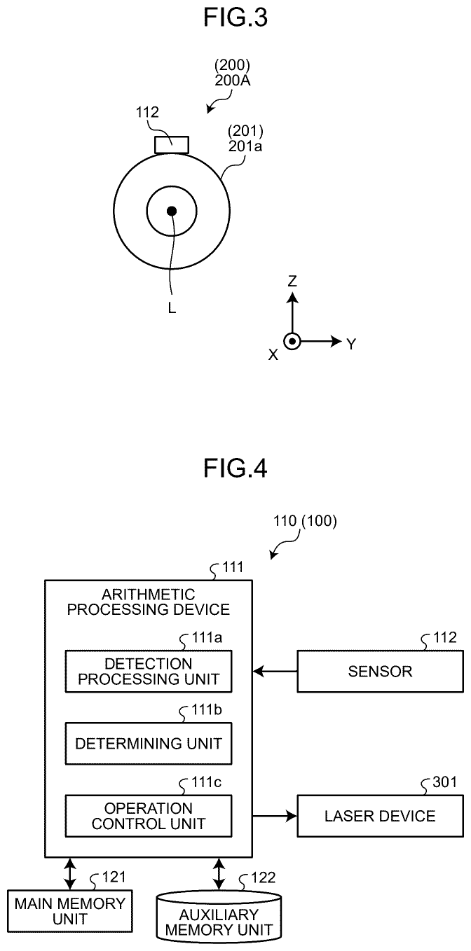

FIG. 3 is a front view of a laser irradiation device 200A (200) according to the first embodiment. As illustrated in FIGS. 1 and 3, in the first embodiment, a sensor 112 is disposed on a surface 201a of the housing 201 of the laser irradiation device 200A. The sensor 112 detects a physical quantity that changes according to the state of irradiation of the laser light L.

FIG. 4 is a block diagram of a control device 110 that controls the output of the laser light output by the laser device 301. The control device 110 includes an arithmetic processing unit 111, a main memory unit 121, an auxiliary memory unit 122, the sensor 112, and a laser device 301. The arithmetic processing unit 111 is a processor (circuit) such as a central processing unit (CPU) that runs according to computer programs. The main memory unit 121 is, for example, a random access memory (RAM) or a read only memory (ROM). The auxiliary memory unit 122 is, for example, a hard disk drive (HDD) or a solid state drive (SSD). The arithmetic processing unit 111 includes a detection processing unit 111a, a determining unit 111b, and an processing control unit 111c.

The detection processing unit 111a obtains the detection value (data) according to the physical quantity detected by the sensor 112. The sensor 112 and the detection processing unit 111a represent an example of a detection processing unit. Meanwhile, sometimes the detection processing unit 111a is included in the sensor 112. The data obtained by the detection processing unit 111a represents an example of control data.

The determining unit 111b compares the detection value, which is obtained by the detection processing unit 111a, with the type of the sensor 112 or with a predetermined threshold value set according to other conditions.

According to the determination result obtained by the determining unit 111b, the processing control unit 111c controls the output power of the laser light coming from the laser device 301. The processing control unit 111c (the control device 110) represents an example of a control unit that, based on the detection value obtained by the sensor 112, controls the power of the laser light L output from the laser irradiation device 200.

The sensor 112 may be, for example, an area temperature sensor such as an infrared thermography camera. In that case, the sensor 112 obtains the intensity of the far-infrared rays radiated from a material at each position of the two-dimensional detection range. That is, the sensor 112 obtains the intensity distribution of far-infrared rays. The intensity of far-infrared rays represents an example of a physical quantity that changes according to the state of irradiation of the laser light L. The sensor 112 and the detection processing unit 111a represent an example of a temperature detection processing unit, and may also be called an area temperature detection processing unit.

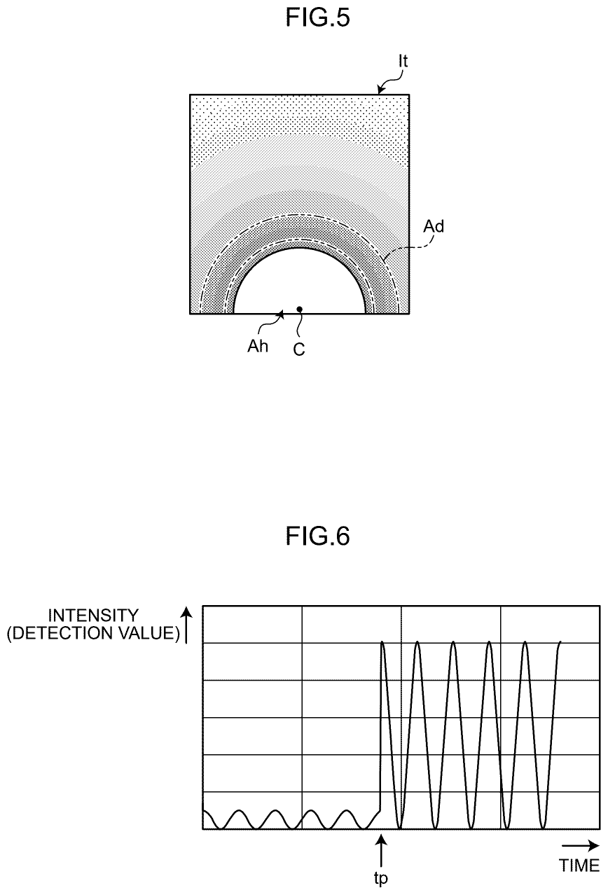

In FIG. 5 is illustrated an example of an image It that indicates the temperature distribution representing the detection value at each position on the surface la. In the image It, the regions are divided according to the temperature range; and, higher the average temperature of the temperature range in an area, the finer is the mesh of the dot pattern in that area. Thus, lower the average temperature of the temperature range in an area, the coarser is the mesh of the dot pattern in that area. As illustrated in FIG. 5, the temperature distribution on the surface la represents a radial distribution in which the temperature goes on increasing toward the center C (see FIG. 2) and goes on decreasing in the directions away from the center C. In that case, the detection processing unit 111a is disposed inside the sensor 112. The sensor 112 represents an example of a temperature sensor that remotely detects the temperature of the surface la. In FIG. 5, a colorless area Ah that is close to the center C is an area in which the temperature has exceeded the upper limit of the detectible temperature range of the infrared thermography camera.

The determining unit 111b obtains, from the sensor 112, two-dimensional temperature distribution data indicating the temperature distribution as illustrated in FIG. 5. Then, as illustrated in FIG. 5, within an area Ad that is either an arc-shaped area, or a partially ring-shaped area, or a ring-shaped area having a substantially constant width in the radial direction of the center C, the determining unit 111b determines whether or not there are points at which the temperature is equal to or higher than a threshold value. Herein, the threshold value represents an example of a fourth threshold value.

When the determining unit 111b determines that there are points in the arc-shaped area Ad at which the temperature is equal to or higher than the threshold value, the processing control unit 111c controls the laser device 301 to lower the output power of the laser light to be smaller than a predetermined value.

Moreover, the determining unit 111b determines whether or not there are points in the area Ad at which the temperature has become equal to or lower than a threshold value. When the determining unit 111b determines that there are points in the area Ad at which the temperature has become equal to or lower than the threshold value, the processing control unit 111c controls the laser device 301 to increase the output power of the laser light. As a result, for example, it becomes possible to hold down a situation in which the temperature of the surface la drops excessively due to the continuation of the low output mode. Herein, the threshold value is lower than the fourth threshold value, and represents an example of a fifth threshold value.

According to the determination that is based on the detection value obtained by the sensor 112 representing the area temperature sensor as explained earlier, in the case of controlling the laser device 301 to lower the output power of the laser light, the processing control unit 111c may control the laser device 301 in such a way that the laser irradiation device 200 switches from the state of outputting the laser light L in the normal output mode to the state of outputting the laser light L in the low output mode.

For example, the sensor 112 may be an intensity sensor such as a photodiode that detects the intensity of the light coming from the surface la or coming from a position closer to the laser irradiation device 200 than the surface 1a. In that case, the detected light is either the scattered light or the reflected light coming from the surface la or coming from the smoke present between the surface la and the laser irradiation device 200. The intensity of the light represents an example of a physical quantity that changes according to the state of irradiation of the laser light L. Moreover, the sensor 112 and the detection processing unit 111a represent an example of an intensity detection processing unit.

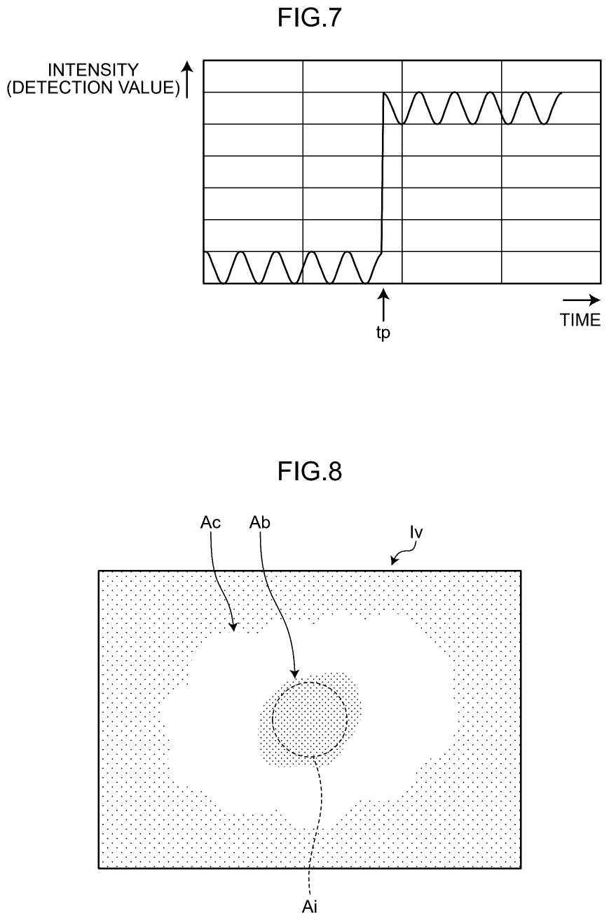

FIGS. 6 and 7 are graphs illustrating examples of temporal changes occurring in the detection values (the light intensities) obtained by the detection processing unit that includes the sensor 112. In the examples illustrated in FIGS. 6 and 7, after a timing tp, the time waveform of the intensity changes and the average detection value per unit time increases.

In the example illustrated in FIG. 6, after the timing tp, although the minimum value does not change; the average value, the maximum value, and the amplitude change in a significant way. For example, after the timing tp, such temporal changes are seen when there is an increase in the intensity of the reflected light toward a specific direction.

In the example illustrated in FIG. 7, after the timing tp, although the amplitude does not change; the minimum value, the maximum value, and the average value change in a significant way. For example, after the timing tp, such temporal changes are seen when there is an increase in the intensity of the reflected light toward a specific direction.

In the cases illustrated in FIGS. 6 and 7, it is not desirable to have the continuation of the state attained after the timing tp. In that regard, for example, the determining unit 111b determines whether or not the detection values have become equal to or greater than a predetermined threshold value for a count equal to or greater than a predetermined count within a predetermined period of time. Alternatively, the determining unit 11b may determine whether or not the time-averaged value of the detection values within a predetermined period of time is equal to or greater than a threshold value. The abovementioned threshold values represent examples of a first threshold value.

For example, when the determining unit 111b either determines that the detection values have become equal to or greater than a predetermined threshold value for a count equal to or greater than a predetermined count within a predetermined period of time or determines that the time-averaged value of the detection values within a predetermined period of time is equal to or greater than a threshold value, the processing control unit 111c controls the laser device 301 to lower the output power of the laser light. In that case, the processing control unit 111c may control the laser device 301 to stop outputting the laser light. As a result, it becomes possible to hold down a situation in which the laser light L is output in a different direction than the desired output direction.

Moreover, the determining unit 111b determines whether or not the ratio of the output power of the laser light, which is output by the laser device 301, with respect to the detection value (the intensity of the light) is equal to or smaller than a predetermined threshold value. When the determining unit 111b determines that the ratio of the output power of the laser light with respect to the detection value is equal to or smaller than the threshold value, the processing control unit 111c may control the laser device 301 to lower the output power of the laser light. In that case too, it becomes possible to hold down a situation in which the laser light L is output in a different direction than the desired output direction. Herein, the threshold value represents an example of a second threshold value.

According to the determination that is based on the detection value obtained by the sensor 112 representing the area temperature sensor as explained earlier, in the case of controlling the laser device 301 to lower the output power of the laser light, the processing control unit 111c may control the laser device 301 in such a way that the laser irradiation device 200 switches from the state of outputting the laser light L in the normal output mode to the state of outputting the laser light L in the low output mode.

For example, the sensor 112 may be an area intensity sensor such as a visible light camera that obtains a two-dimensional luminance image of the light coming from the surface la or coming from a position closer to the laser irradiation device 200 than the surface la. In that case, the detected light is either the scattered light or the reflected light coming from the surface la or coming from the smoke present between the surface la and the laser irradiation device 200. Thus, the sensor 112 detects the intensity of the light at each position. Hence, in that case, the intensity of the light represents an example of a physical quantity that changes according to the state of irradiation of the laser light L. Moreover, the sensor 112 and the detection processing unit 111a represent an example of an area intensity detection processing unit.

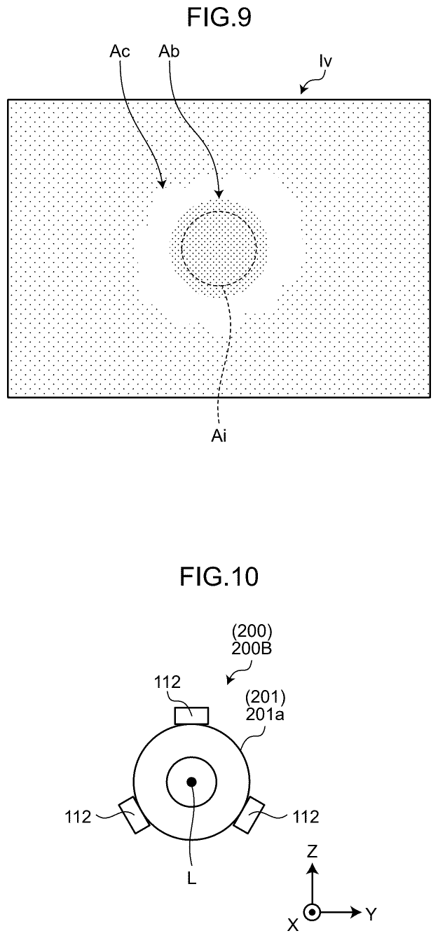

In FIGS. 8 and 9 are illustrated examples of a two-dimensional luminance image Iv obtained by the detection processing unit that includes the sensor 112. In the examples illustrated in FIGS. 8 and 9, an area Ab is included that has high luminance as a result of getting heated by the laser light L, and an area Ac is included that has high luminance due to the scattered light attributed to the smoke generated by the irradiation of the laser light L. The luminance value of the area Ac is higher than the luminance value of the surrounding area, and the luminance value of the area Ab is higher than the luminance value of the area Ac. Hence, by performing image thresholding with respect to the luminance image data using the threshold value of the luminance values, the areas Ab and Ac may be extracted. The extraction of the areas Ab and Ac is performed by, for example, the detection processing unit 111a.

In the example illustrated in FIG. 8, the state is illustrated in which the laser light L has scattered due to the spread of the smoke. In that case, there is a risk of a local decline or local variability in the power density of the laser light L on the surface la. Thus, the determining unit 111b determines whether or not the size of the area Ac is equal to or greater than a predetermined threshold value. When the determining unit 111b determines that the size of the area Ac is equal to or greater than the predetermined threshold value, the processing control unit 111c may control the laser device 301 to lower the output power of the laser light. As a result, it becomes possible to hold down the generation of smoke, and to hold down a local decline or local variability in the power density of the laser light L on the surface la. Moreover, since the asperity of the surface la decreases as the removal of the surface layer progresses, when the irradiated area Ai is substantially circular as illustrated in FIG. 2, the area Ab moves closer to be a circular shape. Thus, the determining unit 111b determines whether or not the roundness of the area Ab is equal to or smaller than a predetermined threshold value. When the determining unit 111b determines that the roundness of the area Ab is equal to or smaller than the predetermined threshold value, the processing control unit 111c may control the laser device 301 to lower the output power of the laser light. In that case too, it becomes possible to hold down the generation of smoke, and to hold down a local decline or local variability in the power density of the laser light L on the surface la. In FIG. 9 is illustrated the state in which, due to the operation performed by the processing control unit 111c as explained above, the state of irradiation of the laser light L with respect to the surface la is improved and the area Ab as well as the area Ac becomes smaller with a higher degree of roundness. In that state, the generation of smoke is held down, and a local decline or local variability in the power density of the laser light L on the surface la is held down.

According to the determination that is based on the detection value obtained by the sensor 112 representing the area intensity sensor as explained earlier, in the case of controlling the laser device 301 to lower the output power of the laser light, the processing control unit 111c may control the laser device 301 in such a way that the laser irradiation device 200 switches from the state of outputting the laser light L in the normal output mode to the state of outputting the laser light L in the low output mode.

As explained above, according to the first embodiment, for example, it becomes possible to obtain the laser surface treatment device 100 of a new and improved type that enables achieving enhancement in the protectiveness and achieving improvement in the state of irradiation of the laser light L.

FIG. 10 is a front view of a laser irradiation device 200B (200) according to a second embodiment. As illustrated in FIG. 10, in the second embodiment, on the surface 201a of the housing 201 of the laser irradiation device 200B, a plurality of sensors 112 is disposed away from each other. In this example, three sensors 112 are disposed. The sensors 112 are disposed in such a way that the virtual line overlapping with the optical axis of the laser light L, which is output from the laser irradiation device 200B, is positioned in between the sensors 112. The virtual line overlaps with the extension line obtained when the optical axis of the laser light L, which is output from the laser irradiation device 200B, is extended from the emitting end in the opposite direction of the direction of emission (the direction of irradiation). As a result of such arrangement, there is an increase in the probability of detecting the reflected light, which travels in various direction from the irradiated area Ai on the surface la, using the sensors 112; and it becomes easier to ensure safety against the reflected light travelling in various directions. Meanwhile, the number of sensors 112 is not limited to three, and there may be two sensors 112 or there may be four or more sensors 112.

Of the three sensors 112 illustrated in FIG. 10, at least two sensors 112 may be of different types. More particularly, for example, one of the sensors 112 may be an area temperature sensor, and another sensor 112 may be an area intensity sensor. In that case, those two sensors 112 may be set to enable obtaining, at least partially, the detection values at the same position on the surface la. With such a configuration, based on the detection values obtained by the sensors 112 of different types, it becomes possible to ensure safety with more reliability.

Alternatively, for example, while ensuring the state in which the temperature in the area Ad (see FIG. 5) is within a predetermined range based on the detection value obtained by one of the sensors 112 representing an area temperature sensor, the condition that the roundness of the area Ab (see FIGS. 8 and 9) as obtained based on the detection value obtained by the area intensity sensor representing another sensor 112 is equal to or smaller than a predetermined threshold value may be treated as the determination criterion for ending the treatment with respect to the irradiated area Ai. With such a configuration and control, it becomes easier to obtain a high-quality treatment surface having less treatment unevenness and high shape accuracy.

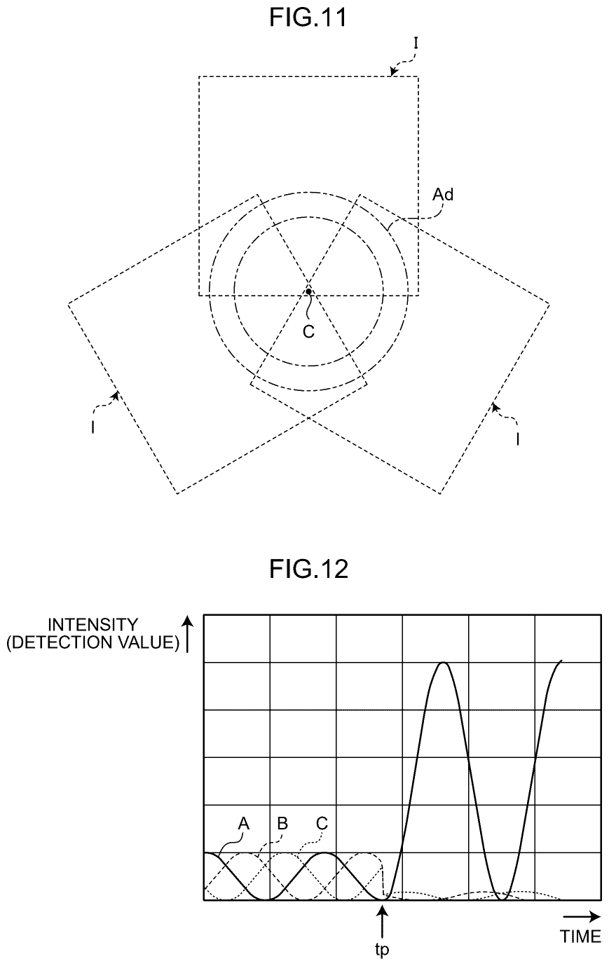

In FIG. 11 is illustrated an example of detection ranges of the temperature distribution that are obtained by three area temperature sensors disposed as the sensors 112 illustrated in FIG. 10. Herein, detection ranges I may also be called imaging ranges. As illustrated in FIG. 11, the detection ranges I have mutually different positions. Moreover, in the example illustrated in FIG. 11, the detection processing unit 111a may synthesize the detection values in the detection ranges I using the sensors 112. More particularly, for example, the detection processing unit 111a takes the average of the temperature values at each position in each detection range I, and obtains the temperature at each overlapping position between two detection ranges. As a result, the operations of the determining unit 111b and the processing control unit 111c may be implemented with respect to wider detection ranges I. Meanwhile, although not illustrated in FIG. 11, the detection ranges I are set to be elongated in the circumferential direction of the center C, so as to enable treatment of wider detection ranges I.

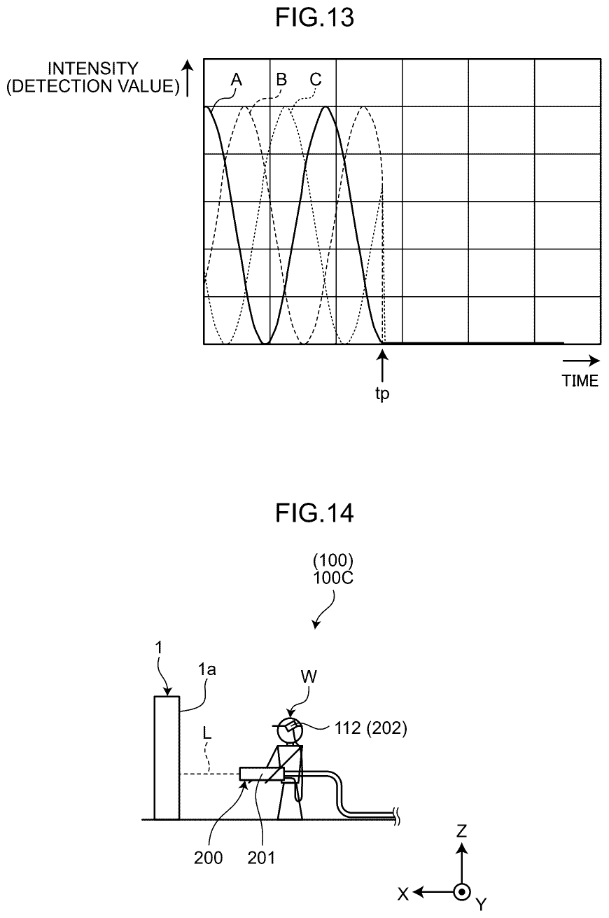

FIGS. 12 and 13 are graphs illustrating examples of temporal changes occurring in the detection values (the light intensities) obtained by the detection processing unit that includes three sensors 112. In the examples illustrated in FIGS. 12 and 13, the three sensors 112 represent intensity sensors; and the time waveform of the intensity changes after the timing tp. Meanwhile, in each graph, the temporal changes in the detection values obtained by the three sensors 112 are differentiated using reference numerals A, B, and C and using different types of lines.

In the example illustrated in FIG. 12, after the timing tp, the amplitude of the intensity detected by one of the sensors 112(A) increases than before, and the amplitudes of the intensities detected by the other two sensors 112(B and C) decrease than before. For example, after the timing tp, such temporal changes are seen when there is an increase in the intensity of the reflected light toward a specific direction.

In the example illustrated in FIG. 13, after the timing tp, the intensity detected by each of the three sensors 112(A, B, and C) is substantially equal to “0”. For example, after the timing tp, such temporal changes are seen when the laser irradiation device 200 is no more facing the surface la or when a position deviated from the surface la happens to get irradiated with the laser light L.

In the cases illustrated in FIGS. 12 and 13, it is not desirable to have the continuation of the state attained after the timing tp. In that regard, for example, the determining unit 111b calculates the difference between the intensities detected by two sensors 112 and determines whether or not the difference is equal to or greater than a predetermined threshold value. The determining unit 111b performs such determination for all combinations of two sensors 112 from among a plurality of sensors 112. For example, when the laser irradiation device 200 includes three sensors 112(A to C), the determining unit 111b performs such determination for three combinations, namely, the sensors A and B, the sensors B and C, and the sensors C and A.

When the determining unit 111b determines that at least one of the differences is equal to or greater than the predetermined threshold value, the processing control unit 111c controls the laser device 301 to lower the output power of the laser light. In that case, the processing control unit 111c may control the laser device 301 to stop outputting the laser light. As a result, it becomes possible to hold down the situation in which the laser light L is output in a different direction than the desired output direction. Herein, the threshold value represents an example of a third threshold value.

Moreover, the determining unit 111b determines whether or not the ratio of the abovementioned difference with respect to the output power is equal to or greater than a predetermined threshold value. When the determining unit 111b determines that the ratio of the abovementioned difference is equal to or smaller than the predetermined threshold value, the processing control unit 111c may control the laser device 301 to lower the output power of the laser light.

In the second embodiment too, According to the determination that is based on the detection values obtained by the sensors 112, in the case of controlling the laser device 301 to lower the output power of the laser light, the processing control unit 111c may control the laser device 301 in such a way that the laser irradiation device 200 switches from the state of outputting the laser light L in the normal output mode to the state of outputting the laser light L in the low output mode.

As explained above, according to the second embodiment, based on the detection values obtained by a plurality of sensors 112, the processing control unit 111c may perform control with more reliability or more accuracy from the perspective of ensuring safety and achieving improvement in the state of irradiation of the laser light.

FIG. 14 is a diagram illustrating an overall configuration of some portion of a laser surface treatment device 100C (100) according to a third embodiment. As illustrated in FIG. 1, common to the embodiments, the sensor 112 is not disposed in the housing 201 of the laser irradiation device 200, but is disposed in an attachment mechanism 202 that is configured separately from the housing 201 and that is detachably-attachable to the worker W. In the example illustrated in FIG. 14, the attachment mechanism 202 is configured as a band that is detachably-attachable to the head of the worker W. With such a configuration, in the vicinity of the body part to which the attachment mechanism 202 is attached, it becomes possible to further enhance the safety of the worker. Meanwhile, the attachment mechanism 202 is not limited to a band and may be a different mechanism than a band, such as a belt, a clip, or a hook-and-loop fastener. Moreover, instead of attaching to the worker W, the attachment mechanism 202 may be detachably-attached to some other object. Thus, according to the third embodiment, the protection against the laser light may be enhanced for a worker who wishes to avoid being irradiated with the laser light, or for an object (for example, a precision equipment), or for a place. Meanwhile, the target for attaching the attachment mechanism 202 may be different than the target for protection from the laser light.

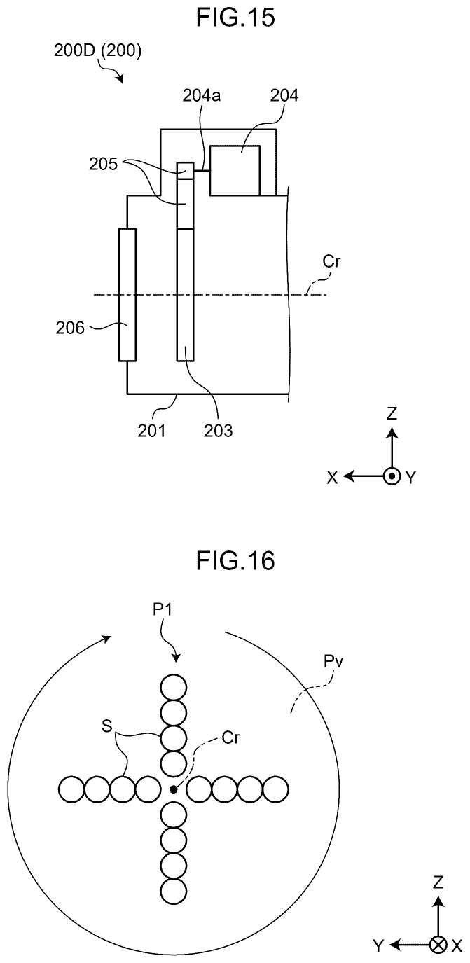

FIG. 15 is a side view of an internal configuration of some portion of a laser irradiation device 200D (200) included in the laser surface treatment device 100 according to a fourth embodiment. As illustrated in FIG. 15, the laser irradiation device 200D includes a diffractive optical element (DOE) 203, a motor 204, a rotation transmission mechanism 205, and a window member 206.

The DOE 203 has a configuration in which, for example, a plurality of diffraction gratings having different periodic structures, and is capable of dividing a laser light passing therethrough into a plurality of beams and arranging the beams in an appropriate manner. FIG. 16 is a planar view illustrating an example of a spot pattern P1 that is formed on a virtual irradiated surface Pv, which intersects with the Y direction, due to the laser irradiation device 200. For example, as illustrated in FIG. 16, the DOE 203 forms the spot pattern P1 that includes a plurality of spots S formed due to a plurality of beams. However, the spot pattern formed by the DOE 203 is not limited to the spot pattern P1 illustrated in FIG. 16. That is, when the DOEs 203 having different configurations are used, it becomes possible to form a variety of spot patterns.

The motor 204 and the rotation transmission mechanism 205 are mechanisms for rotating the DOE 203 around a central axis Cr that substantially runs along the optical axis of the laser light, and represent an example of a rotation mechanism. The rotation transmission mechanism 205 is, for example, a set of gears engaged together, and transmit the rotation of a shaft 204a of the motor 204 to a ring gear disposed on the outer periphery of the DOE 203. The rotation transmission mechanism 205 may also be called a deceleration mechanism. As illustrated in FIG. 16, accompanying the rotation of the shaft 204a of the motor 204, the spot pattern Pl rotates around the central axis Cr. The window member 206 is fit into an opening formed in the housing 201, and lets the laser light pass through it.

With such a configuration, accompanying the rotation of the DOE 203, the spot pattern Pl rotates around the central axis Cr on the virtual irradiated surface Pv at a substantially constant angular velocity over time. As a result, the spots S of a plurality of beams having the power density appropriately adjusted by the DOE 203 may be rotated on the surface la. Hence, for example, as compared to the case in which there is rotation, on the surface la, of the spot of a single beam not having the power density particularly adjusted, it becomes possible to hold down the variability in the power density depending on the position on the surface la, and in turn it becomes possible to hold down the variability attributed to the position in the treatment state on the surface la. Meanwhile, the spot pattern P1 does not include the spots S in the vicinity of the central axis Cr. Hence, the vicinity of the central axis Cr gets continuously irradiated with the laser light, and it becomes possible to hold down an increase in the energy density as compared to other body parts. Moreover, as a result of varying the speed of rotation of the shaft 204a of the motor 204, the speed of rotation of the spot pattern P1 may be varied. When the rotation of the spot pattern P1 is combined with the movement of the center of gravity of the spot pattern P1, that is, combined with the scanning, the speed of rotation and the speed of movement may be appropriately adjusted, and the energy density of the laser light on the surface la may be varied in a suitable manner. The rotation of the DOE 203 as well as the rotation of the optical components in the abovementioned laser scanner is same from the perspective of causing rotation of the spots S. Hence, also regarding controlling the rotation of the spots S according to the first embodiment, it becomes possible to perform identical control to controlling the rotation of the DOE 203. The control of the rotation and scanning of the spots S and the spot pattern P1 as performed by the control device 110 represents an example of the control for (varying) the irradiation position of the laser light.

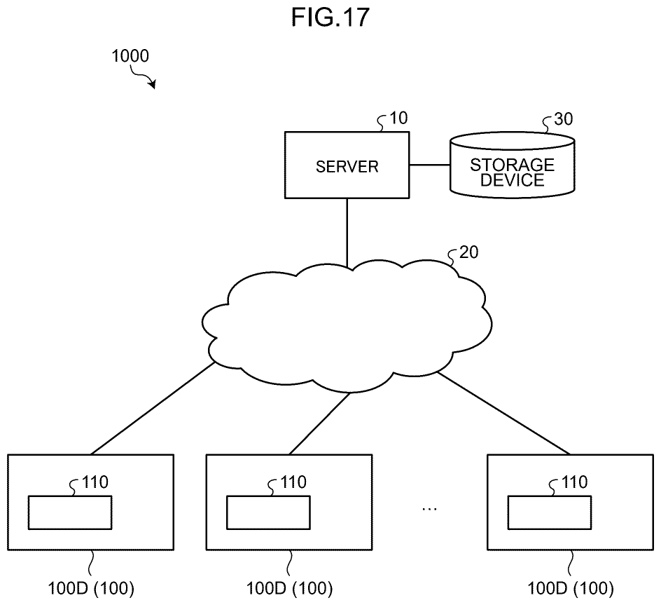

FIG. 17 is an overall configuration diagram of a laser surface treatment system 1000 according to a fifth embodiment. The laser surface treatment system 1000 includes a server 10, a storage device 30, and a plurality of laser surface treatment devices 100D (100). The server 10 and the laser surface treatment devices 100D are electrically connected to each other via a telecommunications line 20. Moreover, the storage device 30 is also electrically connected to the server 10. The server 10 may read data from and write data into the storage device 30. The laser surface treatment device 100D may download the data from the storage device 30 via the telecommunications line 20 and the server 10. Moreover, the server 10 may upload control data, which is related to the treatment performed in the laser surface treatment device 100D, in the storage device. The telecommunications line 20 represents a network for communicating data in a wired manner or a wireless manner and, for example, is configured using the Internet, a local area network, a wide area network, or an intranet. The server 10 is electrically connected to the control device 110 of each laser surface treatment device 100D in a communicable manner via the telecommunications line 20. Meanwhile, the server 10 and the storage device 30 may be electrically connected to each other via the telecommunications line 20.

The storage device 30 stores therein a variety of control data related to the surface treatment control performed by the control device 110 of the laser surface treatment device 100D. The control data indicates, for example, the values and the ranges of the parameters used in the control, the processing sequence, threshold values, unusual events exceeding threshold values, and the quality of the processing state (treatment state). The storage device 30 is, for example, a RAID that may be configured using a plurality of storage devices.

The control data contains the control data corresponding to each processing condition (treatment condition) for the surface treatment under normal situations, as well as contains the control data corresponding to abnormal situations such as the threshold values to be referred to at the time of lowering the output power of the laser light coming from the laser device 301.

The server 10 controls the reading and writing of the control data with respect to the storage device 30, and controls the data communication between the storage device 30 and the control device 110. The server 10 may write, in the storage device 30, the control data sent from each laser surface treatment device 100D. In that case, the control device 110 may send the control data in response to a request received from the server 10, or may send the control data at a predetermined timing.

The control device 110 may send, to the server 10, a variety of control data used during the surface treatment control; and the server 10 may store that control data in the storage device 30. That control data represents, for example, a variety of data containing the data detected by the sensor 112 at the time of a large number of and a variety of surface treatments performed in a plurality of laser surface treatment devices 100D, and containing the data input by the worker W or the operator.

The server 10 may also function as an analysis device. In that case, the server 10 may perform machine learning or deep learning based on the data collected in the storage device 30 from a plurality of laser surface treatment devices 100D, and may decide on the control data indicating the control parameters (the values or the range of values) or indicating the sequence of control suitable for the type of surface treatment. Meanwhile, the server 10 may be configured to calculate the average value of the control parameters in various cases.

When the control device 110 performs control to lower the output power of the laser light coming from the laser device 301, based on the data indicating the physical quantities obtained within a predetermined period of time before the point of time at which the control was performed; the server 10 functioning as the analysis device may obtain, as the control data, the data serving as an indication of the changes in various physical quantities leading to the control. The data serving as an indication represents, for example, the distance to the subject, the surface temperature of the subject, and the orientation and the temperature of the laser irradiation device 200. Based on such data or based on the comparison with the threshold values corresponding to the temporal changes in such data, it is possible to recognize the indication of the situation in which the control is performed for lowering the output power of the laser light.

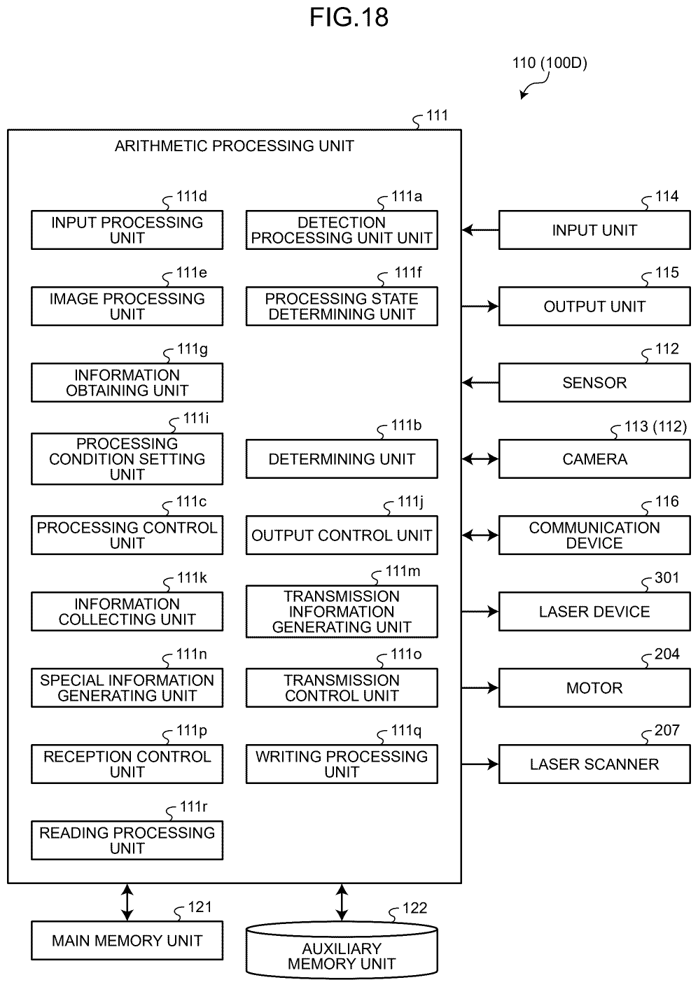

Moreover, the server 10 sends the control data, which is stored in the storage device 30, to the control device 110 of each laser surface treatment device 100D. That is, the control data is downloaded to each laser surface treatment device 100D via the server 10 and the telecommunications line 20, and is stored in the auxiliary memory unit 122 (see FIG. 18) of that laser surface treatment device 100D. In that case, the server 10 may send the control data in response to a request issued by the control device 110, or may send the control data at a predetermined timing.

With such a configuration, in the laser surface treatment system 1000, the control data is collected from a plurality of laser surface treatment devices 100D, is then analyzed, and is stored in the storage device 30. During a variety of surface treatment, each laser surface treatment device 100D becomes able to download, from the storage device 30, the stored control data or the control data obtained as a result of performing analysis, and becomes able to effectively utilize the control data for performing surface treatment in a more suitable manner.

FIG. 18 is a block diagram of a control device 110 of the laser surface treatment device 100D according to the fifth embodiment. The control device 110 includes the arithmetic processing unit 111, the sensor 112, a camera 113, an input unit 114, an output unit 115, a communication device 116, the laser device 301, and the auxiliary memory unit 122.

The input unit 114 is, for example, a touch-sensitive panel, a keyboard, or a push button; and electrically obtains an operation input performed by the worker W or an operator.

The output unit 115 is a display output unit such as an LED or a display; or is a sound output unit such as a speaker or a buzzer.

The sensor 112 is a sensor for controlling the surface treatment, or for detecting a physical quantity related to the state of the laser irradiation device. Examples of the sensor 112 include a temperature sensor, a rotation speed sensor, a voltage sensor, a current sensor, a water leak sensor, a distance sensor, an acceleration sensor, a gyro sensor, a compass, a piezoelectric device, and a GPS. Of those types, an acceleration sensor, a gyro sensor, a compass, and a GPS represent the sensors that detect the position and the orientation of the laser irradiation device 200. Moreover, examples of a distance sensor include a laser range finder, a LiDAR, an ultrasonic sensor, a camera, and an RGB-D sensor.

Any such sensor 112 may also function as the sensor 112 to be used in ensuring safety according to the first embodiment. That is, for example, when the detection values obtained by the sensor 112 include detection values exceeding threshold values corresponding to various abnormal events in the laser irradiation device 200, such as abnormally high temperature of the laser irradiation device 200, a sudden rise in the temperature of the laser irradiation device 200, a fall of the laser irradiation device 200, or collision or falling down of the worker W, or when there occur temporal changes in the detection values exceeding a predetermined threshold value; the processing control unit 111c may control the laser device 301 to lower the output power of the laser light.

Examples of the camera 113 include a visible light camera, an infrared camera, and an RGB-D sensor. The camera 113 also represents an example of the sensor 112.

The communication device 116 sends the control data to and receives the control data from the server 10 in a wired manner or a wireless manner via the telecommunications line 20.

The arithmetic processing unit 111 includes the detection processing unit 111a, the determining unit 111b, the processing control unit 111c, an input processing unit 111d, an image processing unit 111e, a processing determining unit 111f, an information obtaining unit 111g, a processing condition setting unit 111i, an output control unit 111j, an information collecting unit 111k, a transmission information generating unit 111m, a special information generating unit 111n, a transmission control unit 1110, a reception control unit 111p, a writing processing unit 111q, and a reading processing unit 111r. The arithmetic processing unit 111 performs arithmetic processing according to computer programs that are installed; and functions as the detection processing unit 111a, the determining unit 111b, the processing control unit 111c, the input processing unit 111d, the image processing unit 111e, the processing determining unit 111f, the information obtaining unit 111g, the processing condition setting unit 111i, the output control unit 111j, the information collecting unit 111k, the transmission information generating unit 111m, the special information generating unit 111n, the transmission control unit 111o, the reception control unit 111p, the writing processing unit 111q, and the reading processing unit 111r.

The input processing unit 111d obtains the data according to an operation input performed using the input unit 114. The data obtained by the input processing unit 111d represents an example of the control data.

The image processing unit 111e performs predetermined image processing with respect to the image data obtained by the camera 113. The image data processed by the image processing unit 111e and the data of values represent examples of the control data.

The processing state determining unit 111f analyzes the image data that has been subjected to image processing by the image processing unit 111e, and determines the quality of the state of surface treatment on the surface la of the subject 1 which has been subjected to surface treatment. According to the subject or according to the type of the subject layer to be removed, the processing state determining unit 111f may compare the data obtained as a result of performing image analysis with the data corresponding to the state of excellent treatment or with the data corresponding to the state of poor treatment; and, for example, may determine the quality or the extent of the processing state based on the ratio of the dimensions of the area having higher luminance than a threshold value with respect to the overall dimensions.

The information obtaining unit 111g may obtain the data indicating the quality of the processing state as input using the input unit 114. The data obtained by the information obtaining unit 111g represents an example of the control data.

The processing condition setting unit 111i obtains the data that is input using the input unit 114 and obtained by the input processing unit 111d and that enables identification of the type and the details of the surface treatment to be performed thereafter, such as the data indicating the material of the subject 1 or indicating the target for removal. Then, the processing condition setting unit 111i refers to the auxiliary memory unit 122; obtains the values or the range of values of the suitable control data corresponding to the data enabling identification of the type and the details of the surface treatment; and sets the obtained information as the values or the range of values of the control data indicating the processing conditions (treatment conditions) corresponding to that surface treatment.

As an example, as illustrated below in Table 1, for each material of the subject 1 (preform) (for example, iron, steel, brass, copper, or zinc) and for each target for removal from the surface la (for example, the types of rust such as red rust, black oxide, or white rust), the value (range) of the power of the laser device 301 and the value (range) of the speed of rotation of the DOE 203 or the shaft 204a of the motor 204 are stored in the auxiliary memory unit 122.

TABLE 1

| | Iron | Steel | Brass | Copper | Zinc |
|---|---|---|---|---|---|
| Red rust | Power: | Power: | — | — | — |
| | 700 W | 700 W | | | |
| | Speed of | Speed of | | | |
| | rotation: | rotation: | | | |
| | 1000 rpm | 1000 rpm | | | |
| Black Rust | Power: | Power: | — | — | — |
| | 700 W | 700 W | | | |
| | Speed of | Speed of | | | |
| | rotation: | rotation: | | | |
| | 1500 rpm | 1500 rpm | | | |
| White rust | — | — | — | — | Power: |
| | | | | | 700 W |
| | | | | | Speed of |
| | | | | | rotation: |
| | | | | | 2000 rpm |
| Green rust | — | — | Power: | Power: | — |
| | | | 700 W | 700 W | |
| | | | Speed of | Speed of | |
| | | | rotation: | rotation: | |
| | | | 500 rpm | 500 rpm | |

Moreover, for example, as illustrated below in Table 2, in addition to the material of the subject 1 (preform) and the target for removal, for each specification of the target for removal (for example, the rust thickness) too, the value (range) of the power of the laser device 301 and the value (range) of the speed of rotation of the DOE 203 or the shaft 204a of the motor 204 may be stored in the auxiliary memory unit 122.

TABLE 2

| | Rust | Rust | Rust | Rust | Rust |
|---|---|---|---|---|---|
| | thickness | thickness | thickness | thickness | thickness |
| | 50 μm | 100 μm | 200 μm | 300 μm | 500 μm |
| Red rust | Power: | Power: | Power: | Power: | Power: |
| | 700 W | 700 W | 700 W | 700 W | 700 W |
| | Speed of | Speed of | Speed of | Speed of | Speed of |
| | rotation: | rotation: | rotation: | rotation: | rotation: |
| | 1000 rpm | 1000 rpm | 500 rpm | 500 rpm | 500 rpm |

Furthermore, for every surface treatment that is carried out, the value (range) of the power of the laser device 301 and the value (range) of the speed of rotation of the DOE 203 or the shaft 204a of the motor 204 are stored in the auxiliary memory unit 122. In Table 3 given below, when the subject 1 (preform) is made of a metal and when the target for removal is a synthetic resin material, the value (range) of the power of the laser device 301 and the value (range) of the speed of rotation of the DOE 203 or the shaft 204a of the motor 204 are set for each material of the preform (for example, steel, stainless steel, aluminum, copper, or glass) and for each target for removal (for example, epoxy resin, urethane resin, or fluorocarbon resin).

TABLE 3

| | Iron | Steel | Aluminum | Copper |
|---|---|---|---|---|
| Epoxy resin | Power: 700 W | Power: 700 W | Power: 700 W | Power: 700 W |
| | Speed of | Speed of | Speed of | Speed of |
| | rotation: 1000 | rotation: 1000 | rotation: 500 | rotation: 500 |
| | rpm | rpm | rpm | rpm |
| Urethane | Power: 700 W | Power: 700 W | Power: 700 W | Power: 700 W |
| resin | Speed of | Speed of | Speed of | Speed of |
| | rotation: 1000 | rotation: 1000 | rotation: 500 | rotation: 500 |
| | rpm | rpm | rpm | rpm |
| Fluorocarbon | Power: 700 W | Power: 700 W | Power: 700 W | Power: 700 W |
| resin | Speed of | Speed of | Speed of | Speed of |
| | rotation: 1000 | rotation: 1000 | rotation: 500 | rotation: 500 |
| | rpm | rpm | rpm | rpm |

Meanwhile, the materials of the subject 1, the targets for removal, and the specifications of the targets for removal are not limited to the examples illustrated in the tables given above.

The processing control unit 111c controls the operations of the laser device 301, the motor 204, and the laser scanner 207 in such a way that the surface treatment is performed according to the processing conditions (treatment conditions) set by the processing condition setting unit 111i.

The output control unit 111j controls the operations of the output unit 115 so as to ensure a predetermined display output or a predetermined sound output. Moreover, in the detection values obtained by the sensors 112, when there are detection values exceeding threshold values corresponding to various abnormal events in the laser irradiation device 200 or when there occur temporal changes in the detection values exceeding a predetermined threshold value, the output control unit 111j may control the output unit 115 to output a predetermined warning.

The information collecting unit 111k collects the detection values, which correspond to the physical quantities and which are detected by the sensors 112 and obtained by the detection processing unit 111a, at predetermined timings, such as at regular intervals, during the period of time from the start of processing (treatment) to the end of processing (treatment); and stores the detection values in the auxiliary memory unit 122. The start of processing and the end of processing is determined, for example, based on the data that is input using the input unit 114, that is obtained by the input processing unit 111d, and that indicates an operation for starting the processing. Moreover, the point of time at which the laser device 301 starts the output may be treated as the start of processing. The information collecting unit 111k may collect the data, which is obtained by the input processing unit 111d according to an operation input performed using the input unit 114, along with the timing; and may store the collected information in the auxiliary memory unit 122.

The transmission information generating unit 111m picks up the data corresponding to a predetermined condition from among the control data stored in the auxiliary memory unit 122, and generates transmission information to be sent to the server 10. For example, the transmission information may contain unsent data from among all data (control data) related to the surface treatment control, or may contain only the specified data from among the unsent data. Moreover, the transmission information may contain the control data that is collected by the information collecting unit 111k during the period of time from the start of processing to the end of processing. In that case, regarding a plurality of processing, the transmission information may contain the control data collected for each processing.

During the surface treatment, when an event satisfying a specific condition occurs, the special information generating unit 111n generates special information that contains the data indicating the event. The special information too is sent to the server 10. Thus, the special information represents an example of the transmission information. For example, when there occurs an abnormal situation such as performing control to lower the output power of the laser light of the laser device 301, the special information contains data about the physical quantities as obtained within a predetermined period of time before the point of time at which the control was performed. In that case, the special information may contain the data obtained by the input processing unit 111d according to an operation input performed using the input unit 114.

The transmission control unit 1110 controls the communication device 116 to send the transmission information or the special information to the server 10. The reception control unit 111p controls the communication device 116 to receive information from the server 10. Then, the reception control unit 111p downloads the data that is sent from the server 10. That data represents an example of the control data.

The writing processing unit 111q controls the writing of the data in the auxiliary memory unit 122. The writing processing unit 111q obtains the data received by the reception control unit 111p, that is, obtains the downloaded data, and writes that data in the auxiliary memory unit 122. At that time, the data stored in the auxiliary memory unit 122, for example, the data illustrated in Table 1 to Table 3 gets updated by the downloaded data. As explained above, based on the data stored in the auxiliary memory unit 122, the processing condition setting unit 111i sets the processing conditions (treatment conditions), and the processing control unit 111c performs surface treatment according to the processing conditions set by the processing condition setting unit 111i. Hence, in the laser surface treatment device 100, surface treatment may be performed under latest and more suitable processing conditions.

While certain embodiments and modification examples have been described, these embodiments and modification examples have been presented by way of example only, and are not intended to limit the scope of the disclosure. The accompanying claims and their equivalents are intended to cover such forms or modifications as would fall within the scope and spirit of the disclosure. Moreover, regarding the constituent elements, the specifications about the configurations and the shapes (structure, type, direction, shape, size, length, width, thickness, height, number, arrangement, position, material, etc.) may be suitably modified.

For example, during one or more trials of surface treatment using a laser surface treatment device, the control unit of the laser surface treatment device may obtain the control data based on the detection values obtained by the sensors as well as may determine the quality or the extent of the processing state based on the obtained control data (for example, image data). In that case, while referring to the memory unit of the laser surface treatment device or while referring to a storage device that is electrically connected via a telecommunications line, the control unit may perform arithmetic processing (for example, extrapolation, interpolation, and machine learning) based on the control data obtained during the trials, may obtain the control data that is expected to enable achieving improvement in the processing state, and may set that control data as the control data to be used during subsequent surface treatment. At that time, the candidate control data may be output from the output unit using a display, and the operator may be made to select and confirm the control data by performing an operation input using the input unit; and accordingly the control data to be used during subsequent surface treatment may be decided.

According to the present disclosure, for example, it becomes possible to obtain a laser surface treatment device and a laser surface treatment system of a new and improved type that enable achieving enhancement in the protectiveness and achieving improvement in the state of laser irradiation.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A laser surface treatment device comprising:
a laser device configured to output laser light;
an optical head configured to irradiate a surface of an object with the laser light output from the laser device;
a detection processing unit configured to detect a physical quantity that changes according to irradiation of the laser light; and
a control unit configured to control, based on the physical quantity detected by the detection processing unit, at least either power of the laser light output from the optical head or an irradiation position of the laser light on the surface, wherein
treatment of the surface is carried out by irradiating the surface with the laser light.

2. The laser surface treatment device according to claim 1, wherein the detection processing unit includes an intensity detection processing unit configured to detect intensity of light coming from the surface or from a position closer to the optical head than the surface.

3. The laser surface treatment device according to claim 2, wherein the control unit is configured to control the laser device to lower output power of the laser light when the detected intensity of light is equal to or greater than a first threshold.

4. The laser surface treatment device according to claim 2, wherein the control unit is configured to control the laser device to lower output power of the laser light when a ratio of the detected intensity of light with respect to the output power of the laser light is equal to or smaller than a second threshold.

5. The laser surface treatment device according to claim 2, wherein the intensity detection processing unit includes a plurality of intensity detection processors disposed at positions separated from each other.

6. The laser surface treatment device according to claim 5, wherein sensors of the plurality of intensity detection processors are disposed in such a way that an optical axis of the laser light output from the optical head or a virtual line overlapping with the optical axis is positioned in between the sensors.

7. The laser surface treatment device according to claim 5, wherein the control unit is configured to control the laser device to lower the output power of the laser light when a difference between intensities of light detected by two intensity detection processors is equal to or greater than a third threshold.

8. The laser surface treatment device according to claim 2, wherein the intensity detection processing unit includes an area intensity detection processing unit configured to obtain a two-dimensional luminance image.

9. The laser surface treatment device according to claim 1, wherein the detection processing unit includes a temperature detection processing unit configured to remotely detect temperature of the surface.

10. The laser surface treatment device according to claim 9, wherein the control unit is configured to control the laser device to lower output power of the laser light when there is a point at which temperature becomes equal to or higher than a fourth threshold within a predetermined range on the surface.

11. The laser surface treatment device according to claim 9, wherein the control unit is configured to control the laser device to increase output power of the laser light when there is a point at which temperature becomes equal to or lower than a fifth threshold within a predetermined range on the surface.

12. The laser surface treatment device according to claim 11, wherein
the laser surface treatment device is capable of operating in a normal mode and in a low output mode in which output power of the laser light is lower than output power in the normal mode, and
in the low output mode of the laser surface treatment device, the control unit is configured to control the laser device to increase the output power of the laser light and restore the normal mode when there is a point at which temperature becomes equal to or lower than the fifth threshold within the predetermined range on the surface, 1.

13. The laser surface treatment device according to claim 1, wherein the detection processing unit includes a detection unit including a sensor either attached to a housing of the optical head or attached to a housing in which the optical head is housed.

14. The laser surface treatment device according to claim 1, wherein the detection processing unit includes a detection unit including a sensor attached to an attachment mechanism which is attachable to a worker or an object.

15. The laser surface treatment device according to claim 1, wherein
the optical head includes a scanning mechanism configured to move a spot of the laser light on the surface by scanning the spot of the laser light on the surface, and
the control unit is configured to control an operation of the scanning mechanism.

16. The laser surface treatment device according to claim 1, wherein
the optical head includes
a diffractive optical element, and
a rotation mechanism configured to rotate the diffractive optical element so as to rotate a spot of the laser light on the surface, and
the control unit is configured to control an operation of the rotation mechanism.

17. A laser surface treatment system comprising:
a server electrically connected to the control unit of the laser surface treatment device according to claim 1 in a communicable manner via a telecommunications line; and
a storage device configured to store therein control data related to control performed by the control unit, the server reading the control data from the storage device and writing the control data into the storage data, wherein
the server is configured to write, in the storage device, the control data obtained via the control unit.

18. The laser surface treatment system according to claim 17, wherein
the control unit is configured to perform control to lower output power of the laser light based on a physical quantity detected by the detection processing unit, and
the control data contains data that is obtained within a predetermined period of time before point of time at which the control is performed to lower the output power of the laser light.

19. The laser surface treatment system according to claim 17, further comprising a memory disposed corresponding to the control unit and configured to store therein the control data, wherein
the control data stored in the storage device is downloaded via the server and the telecommunications line, and is stored in the memory, and
the control unit is configured to control at least either power of laser light output from the optical head or irradiation position of the laser light on the surface based on the downloaded control data.

20. The laser surface treatment system according to claim 19, further comprising an analysis device configured to calculate, based on the control data stored in the storage device, a value of the control data for each processing condition corresponding to the treatment of the surface or calculate a range of the value, wherein
the value of the control data or the range of the value calculated by the analysis device is stored in the storage device,
the value of the control data or range of the value is downloaded into the memory via the server and the telecommunications line, and
the control unit is configured to control at least either power of laser light output from the optical head or an irradiation position of the laser light on the surface based on the downloaded value of the control data or the range of the downloaded value.

21. The laser surface treatment system according to claim 20, wherein
the control unit is configured to perform the control to lower the output power of the laser light based on the physical quantity detected by the detection processing unit, and
the control data contains data obtained within a predetermined period of time before point of time at which the control is performed to lower the output power of the laser light.

22. The laser surface treatment system according to claim 21, wherein
the analysis device is configured to obtain, as the control data, data serving as an indication of a change in a physical quantity leading to the control of lowering the output power of the laser light based on data obtained within a predetermined period of time before point of time at which the control is performed to lower the output power of the laser light, and
the control unit is configured to perform the control based on the data serving as the indication.
